(19) United States
(12) Patent Application Publication
(10) Pub. No.: US 2025/0155323 A1
(43) Pub. Date: May 15, 2025

(54) AIR-FUEL RATIO CALCULATION DEVICE

(71) Applicant: TOYOTA JIDOSHA KABUSHIKI KAISHA, Toyota-shi (JP)

(72) Inventor: Kazuki TAKAHASHI, Toyota-shi (JP)

(73) Assignee: TOYOTA JIDOSHA KABUSHIKI KAISHA, Toyota-shi (JP)

(21) Appl. No.: 18/830,669

(22) Filed: Sep. 11, 2024

(30) Foreign Application Priority Data
Nov. 10, 2023 (JP) 2023-192448

(51) Int. Cl. G01M 15/10; F02D 41/14; G01N 27/02

(52) U.S. Cl. CPC G01M 15/102; G01N 27/02; F02D 41/1439; F02D 41/1454; F02D 41/1494

(57) ABSTRACT

An air-fuel ratio calculation device is applied to an air-fuel ratio sensor including a sensor element installed in an exhaust passage of an engine and a heater for heating the sensor element. The air-fuel ratio calculation device includes an acquisition unit, an impedance calculation unit, an electric power calculation unit, and an air-fuel ratio calculation unit.

### CROSS-REFERENCE TO RELATED APPLICATION

This application is based upon and claims the benefit of priority of the prior Japanese Patent Application No. 2023-192448, filed on Nov. 10, 2023, the entire contents of which are incorporated herein by reference.

### TECHNICAL FIELD

The present disclosure relates to an air-fuel ratio calculation device.

### BACKGROUND

A device is known to calculate an air-fuel ratio based on an output value of a sensor element of an air-fuel ratio sensor, which includes the sensor element placed in an exhaust passage of an engine and a heater to heat the sensor element. A so-called cold shoot phenomenon may occur while the sensor element is being heated to the activation temperature by the heater. The cold shoot phenomenon is a phenomenon in which the output value of the air-fuel ratio sensor deviates to a rich side with respect to an actual air-fuel ratio of gas (see, for example, Japanese Unexamined Patent Application Publication No. 2009-114992).

The calculation accuracy of the air-fuel ratio might decrease due to such a phenomenon.

### SUMMARY

It is therefore an object of the present disclosure to provide an air-fuel ratio calculation device in which a decrease in calculation accuracy of the air-fuel ratio is suppressed.

The above object is achieved by an air-fuel ratio calculation device applied to an air-fuel ratio sensor including a sensor element installed in an exhaust passage of an engine and a heater for heating the sensor element, the air-fuel ratio calculation device including: an acquisition unit configured to acquire an output value of the sensor element and a target air-fuel ratio of the engine; an impedance calculation unit configured to calculate an impedance of the sensor element; an electric power calculation unit configured to calculate an integrated electric power value supplied to the heater; and an air-fuel ratio calculation unit configured to calculate an air-fuel ratio based on the output value, wherein when the air-fuel ratio corresponding to the output value indicates a rich air-fuel ratio smaller than a theoretical air-fuel ratio, the air-fuel ratio calculation unit is configured to calculate the air-fuel ratio to be leaner as the target air-fuel ratio is leaner, as the impedance is higher, and as the integrated electric power value is smaller.

The electric power calculation unit may be configured to reset the integrated electric power value to zero when the impedance is equal to or greater than a predetermined value and a stop time of the energization of the heater is equal to or greater than a predetermined time, the predetermined value may be an impedance indicating a temperature of the sensor element at which adsorption of an HC component to the sensor element starts, and the predetermined time may be a minimum time at which a cold shoot phenomenon occurs when the engine is started next time.

The electric power calculation unit may be configured to calculate the integrated electric power value based on a voltage applied to the heater and a duty ratio of energization to the heater.

### BRIEF DESCRIPTION OF THE DRAWINGS

FIG. 1A is a schematic configuration view of an engine system, and FIG. 1B is a schematic configuration view of an air-fuel ratio sensor;

FIG. 2 is a flowchart illustrating an air-fuel ratio calculation control;

FIG. 3A and FIG. 3B are exemplary views of maps for calculating the air-fuel ratio;

FIG. 4A and FIG. 4B are exemplary views of maps for calculating the air-fuel ratio; and

FIG. 5 is a flowchart illustrating integrated electric power value calculation control.

### DETAILED DESCRIPTION

### [Schematic Configuration of Engine System]

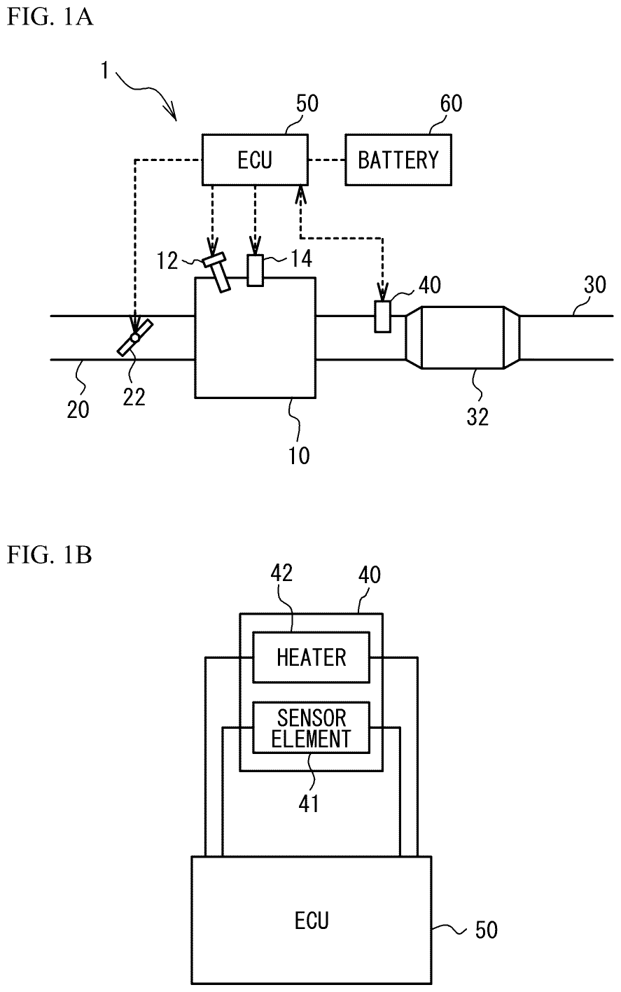

FIG. 1A is a schematic configuration view of an engine system 1. The engine system 1 includes an engine 10, an intake passage 20, and an exhaust passage 30. The engine system 1 is mounted on a vehicle. The vehicle may be, for example, an engine vehicle in which only the engine 10 is mounted as a traveling power source, or a hybrid vehicle including a motor together with the engine 10 as a traveling power source.

The engine 10 is a multi-cylinder engine having a plurality of cylinders. The engine 10 is provided with an in-cylinder injection valve 12 and an ignition plug 14. The in-cylinder injection valve 12 directly injects fuel into a combustion chamber of the engine 10. Note that a port injection valve may be provided instead of the in-cylinder injection valve 12 or in addition to the in-cylinder injection valve. The ignition plug 14 ignites a mixture of fuel and air. A throttle valve 22 is provided in the intake passage 20. The throttle valve 22 is driven by, for example, an actuator (not illustrated) to adjust the intake air amount.

A catalyst device 32 is provided in the exhaust passage 30. The catalyst device 32 purifies harmful components in the exhaust gas when the air-fuel ratio of the exhaust gas flowing into the catalyst device 32 is in a narrow range near the stoichiometric air-fuel ratio. An air-fuel ratio sensor 40 is provided upstream of the catalyst device 32. The air-fuel ratio sensor 40 outputs a signal corresponding to the air-fuel ratio of the exhaust gas flowing into the catalyst device 32. The air-fuel ratio sensor 40 may be provided downstream of the catalyst device 32.

The engine system 1 includes an electronic control unit (ECU) 50. The ECU 50 is mainly configured by a computer including a central processing unit (CPU) and volatile or nonvolatile memory such as random access memory (RAM) and read only memory (ROM). The ECU 50 executes programs installed in the memory to implement various control processes related to the engine 10. The ECU 50 is an example of an air-fuel ratio calculation device, and functionally achieves an acquisition unit, an impedance calculation unit, an electric power calculation unit, and an air-fuel ratio calculation unit.

The ECU 50 calculates an air-fuel ratio of the exhaust gas based on a value output from the air-fuel ratio sensor 40. The ECU 50 performs feedback control of an intake air amount and a fuel injection amount of the engine 10 based on the calculated air-fuel ratio so that the air-fuel ratio of the exhaust gas of the engine 10 becomes the target air-fuel ratio. The target air-fuel ratio is set by the ECU 50 in accordance with the operating state of the engine 10. Further, the ECU 50 performs control for holding the temperature of the sensor element of the air-fuel ratio sensor 40 in an activation temperature region.

### [Schematic Configuration of Air-Fuel Ratio Sensor]

FIG. 1B is a schematic view of the air-fuel ratio sensor. The air-fuel ratio sensor 40 is provided with a sensor element 41 and a heater 42. The sensor element 41 outputs current value corresponding to the air-fuel ratio of the exhaust gas to the ECU 50. The ECU 50 acquires current value output from the sensor element 41 and calculates the air-fuel ratio based on the current value, which will be described in detail later. The ECU 50 detects a voltage applied between electrodes of the sensor element 41 and a current flowing between the electrodes, and calculates an impedance based on the detected voltage and current. The higher the impedance, the lower the temperature of the sensor element 41. The heater 42 raises the temperature of the sensor element 41 to the activation temperature and maintains the sensor element 41 at the activation temperature. A voltage is applied to the heater 42 from a battery 60 via the ECU 50. The ECU 50 controls the duty ratio of the energization of the heater 42.

For example, a so-called cold shoot phenomenon might occur while the sensor element 41 is being heated to the activation temperature by the heater 42 at the time of starting the engine 10. The cold shoot phenomenon is a phenomenon in which the current value output from the air-fuel ratio sensor deviates to the rich side with respect to the actual air-fuel ratio of the gas. The cold shoot phenomenon occurs when HC (hydrocarbon) components in the exhaust passage 30, which are adsorbed on the sensor element 41 when the engine 10 is stopped, are desorbed by the above heating and the atmosphere near the sensor element 41 becomes rich. The desorption of the HC components from the sensor element 41 proceeds with the temperature rise of the sensor element 41 and the elapse of time, and the cold shoot phenomenon is eliminated. However, during the occurrence of such a cold shoot phenomenon, the accuracy of calculation of the air-fuel ratio is reduced. As a result, it becomes difficult to control the actual air-fuel ratio to the target air-fuel ratio, and there is a possibility that the emissions and the drivability might deteriorate. Therefore, the ECU 50 in the present embodiment performs the following air-fuel ratio calculation control.

### [Air-Fuel Ratio Calculation Control]

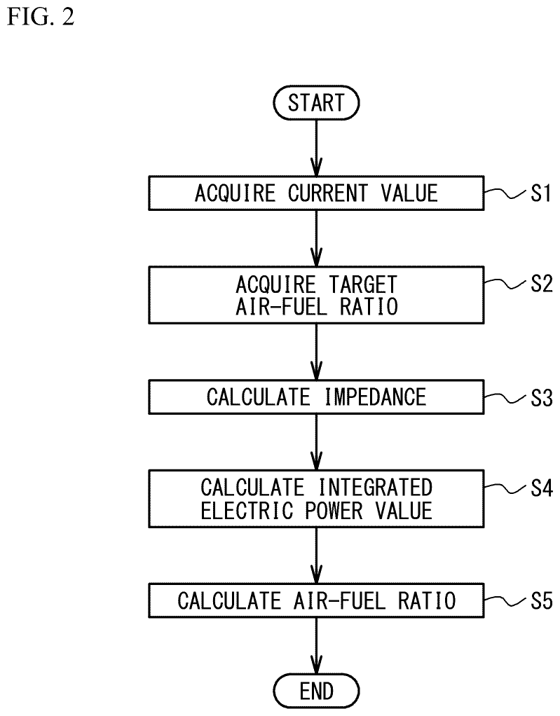

FIG. 2 is a flowchart illustrating an air-fuel ratio calculation control. The ECU 50 acquires a current value output from the sensor element 41 (step S1).

Next, the ECU 50 acquires a target air-fuel ratio of the engine 10 (step S2). Steps S1 and S2 are examples of processes executed by the acquisition unit. Next, the ECU 50 calculates the impedance of the sensor element 41 (step S3). Step S3 is an example of a process executed by the impedance calculation unit. Next, the ECU 50 calculates an integrated value of the electric power supplied to the heater 42 (step S4). Step S4 is an example of a process executed by the power calculation unit. The method of calculating the integrated electric power value will be described in detail later. The order of steps S1 to S4 is not limited.

Next, the ECU 50 calculates the air-fuel ratio based on the output current value, the target air-fuel ratio, the impedance, and the integrated electric power value described above with reference to a map (step S5). Step S5 is an example of a process executed by the air-fuel ratio calculation unit.

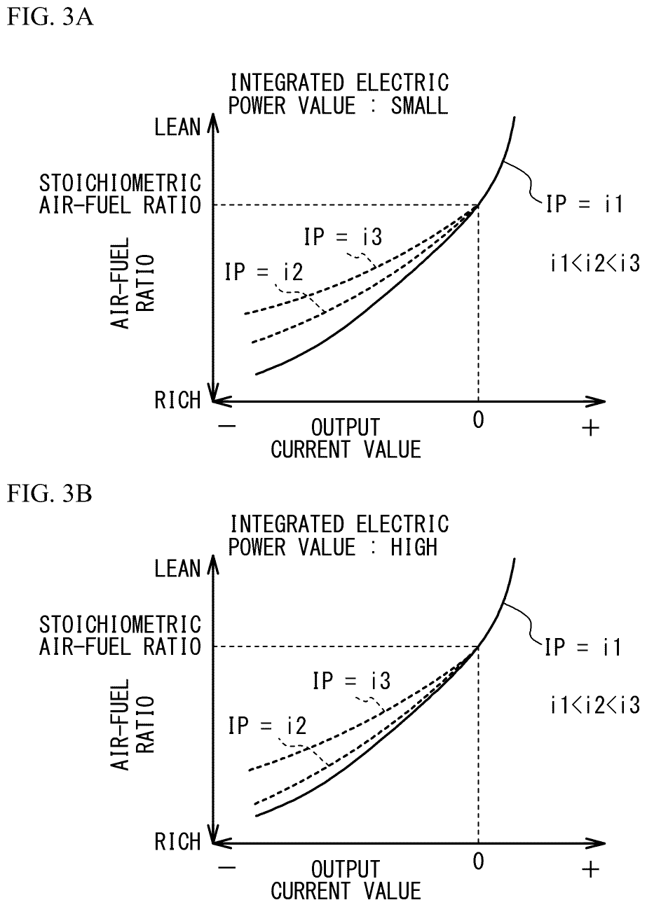

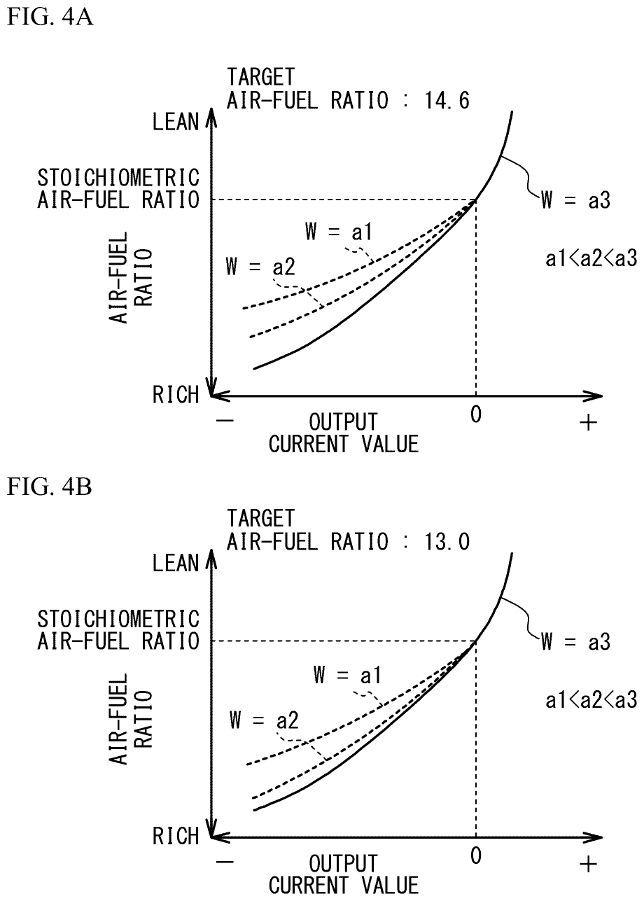

FIGS. 3A to 4B are exemplary views of maps for calculating the air-fuel ratio. In FIGS. 3A to 4B, the vertical axis represents the air-fuel ratio, and the horizontal axis represents the current value output from the sensor element 41. FIG. 3A illustrates the air-fuel ratio corresponding to the impedance when the integrated electric power value is small. FIG. 3B illustrates the air-fuel ratio corresponding to the impedance when the integrated electric power value is high. In the maps of FIG. 3A and FIG. 3B, the target air-fuel ratio is set to the same value. FIG. 4A illustrates the air-fuel ratio corresponding to the integrated electric power value when the target air-fuel ratio is the stoichiometric air-fuel ratio (14.6). FIG. 4B illustrates the air-fuel ratio corresponding to the integrated electric power value when the target air-fuel ratio is a rich air-fuel ratio (13.0). In the maps of FIG. 4A and FIG. 4B, the impedance is the same value. In the ROM of the ECU 50, a plurality of maps having different integrated electric power values and target air-fuel ratios are stored in advance in addition to the maps illustrated in FIGS. 3A to 4B.

In the example of FIGS. 3A and 3B, the case where an impedance IP is a value i1 is indicated by a solid line. The case where the impedance IP is a value i2 higher than the value i1 and the case where the impedance IP is a value i3 higher than the value i2 are respectively indicated by dotted lines. When the output current value is zero, the air-fuel ratio is calculated as the stoichiometric air-fuel ratio (14.6). When the output current value is greater than zero, the air-fuel ratio is calculated as a lean air-fuel ratio. When the output current value is smaller than zero, the air-fuel ratio is calculated as a rich air-fuel ratio.

From the maps of FIG. 3A and FIG. 3B, the air-fuel ratio is calculated as a leaner air-fuel ratio as the impedance of the sensor element 41 increases, when the current value is zero or less. As described above, the higher the impedance of the sensor element 41, the lower the temperature of the sensor element 41. The lower the impedance of the sensor element 41, the higher the temperature of the sensor element 41. When the sensor element 41 is at a low temperature, the HC components adhering to the sensor element 41 is less likely to desorb. When the sensor element 41 is at a high temperature, desorption of the HC components from the sensor element 41 proceeds. However, the actual desorption of the HC components proceeds with the elapsed time from when the sensor element 41 reaches a predetermined temperature. Therefore, the air-fuel ratio is calculated based on the integrated value of the electric power supplied to the heater 42.

As illustrated in FIG. 3A and FIG. 3B, when the power current value is zero or less, the air-fuel ratios are calculated to be leaner as the integrated electric power value is smaller. This is because the proceeding speed of the desorption of the HC components is slow while the integrated electric power value is small, and the proceeding speed of the desorption of the HC components is faster as the integrated electric power value increases, and the shift to the rich side with respect to the actual air-fuel ratio is eliminated.

In the examples of FIGS. 4A and 4B, the case where an integrated electric power value W is a value a3 is indicated by a solid line. The case where the integrated electric power value W is a value a2 lower than the value a3 and the case where the integrated electric power value W is a value a1 lower than the value a2 are respectively indicated by dotted lines. As described above, when the power current value is zero or less, the air-fuel ratios are calculated to be leaner as the integrated electric power value is smaller.

As illustrated in FIG. 4A and FIG. 4B, the leaner the target air-fuel ratio is, the leaner the calculated air-fuel ratio is. Here, the leaner the target air-fuel ratio is, the leaner the actual air-fuel ratio of the gas is. The cold shoot phenomenon occurs when the HC components adhering to the sensor element 41 is desorbed and the atmosphere in the vicinity of the sensor element 41 becomes a rich atmosphere as described above. Therefore, the current value of the sensor element 41 at the time of the occurrence of the cold shoot phenomenon is considered to be independent of the actual air-fuel ratio of the gas. As a result, it is considered that the deviation of the current value output from the sensor element 41 from the actual air-fuel ratio of the gas toward the rich side increases as the target air-fuel ratio is on the lean side, and the deviation of the current value output from the sensor element 41 from the actual air-fuel ratio of the gas toward the rich side decreases as the target air-fuel ratio is on the rich side.

As described above, the air-fuel ratio is calculated with high accuracy based on the output current value, the target air-fuel ratio, the impedance, and the integrated electric power value. Although the air-fuel ratio is calculated based on the maps in the above example, the air-fuel ratio may be calculated by an arithmetic expression using the output current value, the target air-fuel ratio, the impedance, and the integrated electric power value as arguments.

### [Integrated Electric Power Value Calculation Control]

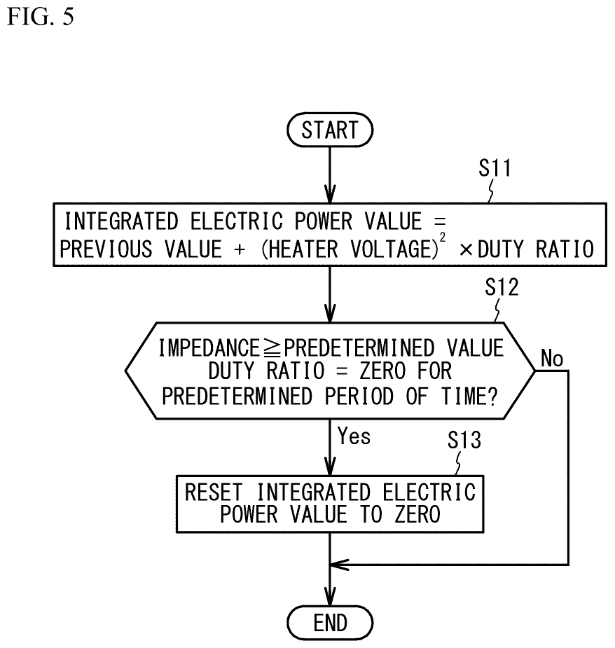

Next, the integrated electric power value calculation control will be described. FIG. 5 is a flowchart illustrating the integrated electric power value calculation control. The ECU 50 calculates the power integrated value by the following equation (1) (step S11).

integrated electric power value=previous value+(heater voltage)²×duty ratio (1)

The previous value is the previously calculated integrated electric power value. The heater voltage is a voltage applied to the heater 42, and corresponds to the voltage of the battery 60 in the present embodiment. The duty ratio is an electric power duty ratio of the heater 42. The ECU 50 calculates the integrated electric power value for each unit time based on the above equation (1).

Next, the ECU 50 determines whether or not the impedance of the sensor element 41 is equal to or higher a predetermined value and the duty ratio is zero for a predetermined period of time (step S12). The impedance being equal to or higher than the predetermined value indicates that the temperature of the sensor element 41 is equal to or lower than the temperature at which the adsorption of the HC components to the sensor element 41 starts. The duty ratio of zero indicates that the engine 10 is in a stopped state and the energization of the heater 42 is stopped. The predetermined time indicates the minimum time in which the cold shoot phenomenon may occur when the engine 10 is started next time. Therefore, when the determination result is Yes in step S12, it is considered that the cold shoot phenomenon may occur at the time of the next start of the engine 10, and the ECU 50 resets the integrated electric power value to zero (step S13).

When the determination result is No in step S12, the control is ended. The case of No in step S12 is, for example, a case where the engine 10 is restarted immediately before the HC components are adsorbed after the engine 10 is stopped. In this case, since the HC components are not adsorbed to the sensor element 41, the integrated electric power value is not reset, and the calculation of the integrated electric power value is continued.

Although some embodiments of the present disclosure have been described in detail, the present disclosure is not limited to the specific embodiments but may be varied or changed within the scope of the present disclosure as claimed.

What is claimed is:

1. An air-fuel ratio calculation device applied to an air-fuel ratio sensor including a sensor element installed in an exhaust passage of an engine and a heater for heating the sensor element, the air-fuel ratio calculation device comprising:
an acquisition unit configured to acquire an output value of the sensor element and a target air-fuel ratio of the engine;
an impedance calculation unit configured to calculate an impedance of the sensor element;
an electric power calculation unit configured to calculate an integrated electric power value supplied to the heater; and
an air-fuel ratio calculation unit configured to calculate an air-fuel ratio based on the output value,
wherein
when the air-fuel ratio corresponding to the output value indicates a rich air-fuel ratio smaller than a theoretical air-fuel ratio, the air-fuel ratio calculation unit is configured to calculate the air-fuel ratio to be leaner as the target air-fuel ratio is leaner, as the impedance is higher, and as the integrated electric power value is smaller.

2. The air-fuel ratio calculation device according to claim 1, wherein
the electric power calculation unit is configured to reset the integrated electric power value to zero when the impedance is equal to or greater than a predetermined value and a stop time of the energization of the heater is equal to or greater than a predetermined time,
the predetermined value is an impedance indicating a temperature of the sensor element at which adsorption of an HC component to the sensor element starts, and
the predetermined time is a minimum time at which a cold shoot phenomenon occurs when the engine is started next time.

3. The air-fuel ratio calculation apparatus according to claim 1, wherein the electric power calculation unit is configured to calculate the integrated electric power value based on a voltage applied to the heater and a duty ratio of energization to the heater.

4. The air-fuel ratio calculation device according to claim 2, wherein the electric power calculation unit is configured to calculate the integrated electric power value based on a voltage applied to the heater and a duty ratio of energization to the heater.
